(19) United States
(12) Patent Application Publication
(10) Pub. No.: US 2009/0128294 A1
(43) Pub. Date: May 21, 2009

(54) DATA STREAMING APPARATUS FOR RADIO FREQUENCY IDENTIFICATION TAG

(75) Inventors: Seon Wook KIM, Namyangju (KR); Young Sun Han, Seoul (KR)

Correspondence Address: RABIN & Berdo, PC, 1101 14TH STREET, NW, SUITE 500, WASHINGTON, DC, 20005, US

(73) Assignee: Korea University Industrial & Academic Collaboration Foundation, Seoul (KR)

(21) Appl. No.: 12/033,770

(22) Filed: Feb. 19, 2008

(30) Foreign Application Priority Data
Nov. 20, 2007 (KR) 10-2007-0118803

(51) Int. Cl. H04Q 5/22

(52) U.S. Cl. 340/10.1

(57) ABSTRACT

The invention relates to a data streaming apparatus for an RFID tag capable of streaming large scale data with low power consumption without a complicated structure. A mass storage is segmented into unit banks, and only the unit banks are selectively operated in a sequential manner. As a result, a tag capable of streaming large scale data with low power consumption can be provided.

### CROSS-REFERENCE TO RELATED PATENT APPLICATION

This application claims the benefit of Korean Patent Application No. 10-2007-0118803, filed on Nov. 20, 2007, in the Korean Intellectual Property Office, the disclosure of which is incorporated herein in its entirety by reference.

### BACKGROUND OF THE INVENTION

1. Field of the Invention

The present invention relates to a radio frequency identification (RFID) tag, and more particularly, to a data streaming apparatus for an RFID tag for facilitating streaming large scale data with low power consumption without a complicated structure.

2. Description of the Related Art

An RFID technology, as one of automatic data collection technologies, includes a reader device and a transmit/receive device, called a tag or transponder, for automatically resending a signal in response to an external signal.

In the nature of the RFID technology, additional information for identifying entities such as humans, vehicles, luggage items, and animals is used. The additional information is decrypted in a contactless manner using wireless communication media in order to automate various existing applications. The RFID technology is considered as an alternative of a bar code system because there is no need to directly contact or scan the codes within a visible range, and is being developed and commercialized in a variety of fields.

Particularly, unlike existing bar code systems, the RFID technology facilitates encrypting or simply updating information, and delivering a larger amount of information faster, so that its applicability is being increased.

Typically, the RFID technology can be classified into a tag-related field and a reader-related field for reading the tag. More specifically, it can be classified into various fields depending on a tag type, a structure of middleware, a structure for providing mobilization, a security-related structure, or the like.

Most of all, the core technology of the RFID is a tag-related field, which should be considered on a top priority in order to deliver information with reduced cost, deliver large scale information for supporting more diverse applications, or deliver secure information with higher reliability.

Basically, the RFID tag technology is used for storing identification codes or information, sensing information of objects, or externally transmitting the stored information depending on a request from a reader device or its conditions. Also, it is a combination of many technologies such as an antenna and a wireless signal processing, a chip manufacturing, a thin-film type battery, a packaging, and an integration chip. The RFID tag is classified into an active tag and a passive tag depending on whether or not it has an independent power source.

The active tag provides a relatively long contactless communication distance and a high communication rate, and facilitates transmission of large scale information. However, since it necessitates a separate power source, it should be periodically maintained. Further, its size can increase or its installation becomes difficult due to an additional power source. Therefore, the active tag has some problems and its applicability is limited.

On the other hand, the passive tag does not necessitate a separate power source because it uses power induced by the reader device. However, its communication distance is short, and it is difficult to use a mass storage due to the limitation of power management. Therefore, its transmission data amount is also limited.

Therefore, there are needs in the art for an RFID tag capable of providing large scale data or multimedia by utilizing advantages of the active tag, aswell as capable of reducing burdens of management or installation by utilizing advantages of the passive tag, so that the RFID tag can be conveniently used in applications for multimedia or large scale information without problem.

On the other hand, there are conventional technologies for reducing power consumption in a mass storage as follows.

A multi-divided arrays technique and an adaptive management technique were developed to solve a power consumption problem of the mass storage in a system level.

In the former technique, the entire memory is segmented into small blocks, and a single block or a group of blocks are selectively operated based on an electric signal of an address line bus, generated when the memory is randomly accessed, in order to save power consumption. This technique is widely employed in the art, including Samsung® 1 GB memory. However, since it necessitates an additional operation called a block selection whenever the memory is accessed, the number of memory access processes increases, and additional delay is generated.

In the latter technique, records for the random memory access are dynamically managed using separate management hardware or an operating system (OS), and only the portions of the memory expected to repeatedly access are operated in order to save power consumption. However, this technique necessitates devices for the dynamic management. Also, serious access delay may be generated when the memory access is erroneously predicted. Furthermore, since tasks for dynamically managing the memory based on the memory access records are naturally complicated, additional power consumption is generated.

The aforementioned conventional techniques fail to consider a sequential address access characteristic of the large scale data streaming, and may cause unnecessary power consumption or delay. Consequently, it is difficult to apply them to the RFID tag which requires transmitting the streaming data with low power consumption.

### SUMMARY OF THE INVENTION

The present invention is contrived to solve the aforementioned problems, and provides a data streaming apparatus for a radio frequency identification (RFID) tag capable of streaming large scale data with low power consumption by segmenting a large scale memory into a plurality of unit banks and selectively operating the unit banks in a sequential manner.

Also, the present invention provides a method of administrating a mass storage in which a passive tag as well as a active tag can be operated using a sequential transmission characteristic of the fixed large scale streaming data, and provides a data streaming apparatus for an RFID tag, by which applicability of the passive tag that has been limited by low power consumption is improved, as well as the battery lifetime of the active tag is extended.

Also, the present invention provides a data streaming apparatus for an RFID tag, by which a mass storage is segmented into small unit banks, and the unit banks are selectively activated in a sequential manner using a sequential transmission characteristic of the fixed large scale streaming data, so that the large scale data can be obtained as desired only with minimum power by using information on an initial address and a data size.

Also, the present invention provides a data streaming apparatus for an RFID tag, by which a control unit is substituted with a memory administration unit which partially operates a mass storage based on an initial address and a data size in order to reduce cost for a tag which provides large scale information.

Also, the present invention provides a data streaming apparatus for an RFID tag, having a mass storage dedicated to fixed data as well as a small scale memory for rewritable data, the mass storage being partially driven depending on necessity in order to minimize power consumption and cover various applications.

According to an aspect of the present invention, there is provided a data streaming apparatus applied to a memory administration means of a tag for radio frequency identification communication, the apparatus comprising: a memory unit including a plurality of unit banks capable of switching between active and inactive states, one or more unit banks sequentially storing one or more pieces of streaming data; and a memory administration unit receiving information on an initial address and a data size or and obtaining and providing data by selectively activating only the unit bank corresponding to a current address while incrementing the current address until the amount of data obtained by incrementing the address starting from the initial address reaches the data size.

The memory unit may be activated or inactivated depending on a selection signal of the memory administration unit, and the address sequentially designates each of the unit banks based on the size of the entire memory unit.

The unit bank of the memory unit may include: an address line bus having a number of lines corresponding to an address size of the unit bank; a single activation signal line controlled by the memory administration unit; and a common data line as an input/output terminal, so that the addressing can be simplified.

The memory administration unit may include: a receive unit receiving the information on the initial address and the data size; an accumulative operation unit generating the current address by incrementing from the initial address until an accumulative data amount reaches the data size; and a selection unit calculating information on unit banks of the memory unit to be currently operated from the address value of the accumulative operation unit and the address of the corresponding unit bank, activating only the corresponding unit bank, and designating the address in the corresponding unit bank.

The memory unit may include information on the initial address and the data size of stored streaming data, and the tag may provide corresponding information or an identifier indicating the information when the tag is connected to a reader device, so as to allow the reader device to request desired pieces of the streaming data.

The memory administration unit may inactivate all unit banks in the memory unit until an external signal notifying that radio transmission of the corresponding data is completed is provided after the obtained data is provided, so as to reduce power consumption generated during the transmission process.

The memory administration unit may inactivate all unit banks in the memory unit if the information on the initial address and the data size is not received or after all information has been provided.

According to another aspect of the present invention, there is provided a data streaming apparatus for a radio frequency identification (RFID) tag, the apparatus comprising: a wireless communication unit exchanging data with an external reader device; a modulation/demodulation unit transmitting/receiving data to/from via wireless communication unit; a memory unit having a plurality of unit banks capable of switching between active and inactive states, one or more pieces of the streaming data being sequentially stored in one or more unit banks; a control unit outputting information for requesting the streaming data stored in the memory unit in response to a streaming data request received via the modulation/demodulation unit and receiving the streaming data accordingly to provide it to the modulation/demodulation unit; and a memory administration unit obtaining data and provide it to the control unit while sequentially activating necessary unit banks in the memory unit based on the information for requesting the streaming data from the control unit.

The control unit may further comprise a state notification means for providing the memory administration unit with information for requesting subsequent data after receiving the streaming data from the memory administration unit and transmitting it to the modulation/demodulation unit, and the memory administration unit may further comprise a synchronization means for sequentially providing the streaming data depending on a transmission state provided by the state notification means of the control unit.

The memory administration unit may inactivate the entire memory unit until receiving the information for requesting subsequent data after providing the control unit with the streaming data, so as to reduce power consumption. This process would be optionally applied.

According to still another aspect of the present invention, there is provided a data streaming apparatus for a radio frequency identification (RFID) tag, the apparatus comprising: a wireless communication unit exchanging data with an external reader device; a modulation/demodulation unit transmitting/receiving data via the wireless communication unit; a memory unit including a plurality of unit banks capable of switching between active and inactive states and sequentially storing one or more pieces of streaming data in one or more unit banks; and a memory administration unit obtaining the streaming data and providing it to the modulation/demodulation unit while sequentially activating necessary unit banks in the memory unit in response to a streaming data request received by the modulation/demodulation unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a basic block diagram illustrating a typical RFID tag;

FIG. 2 is a block diagram illustrating an RFID tag according to an embodiment of the present invention;

FIG. 3 is a block diagram illustrating a memory administration unit and a mass storage according to an embodiment of the present invention;

FIG. 4 is a block diagram illustrating a memory administration unit according to an embodiment of the present invention; and

FIG. 5 is a conceptual diagram illustrating a configuration and operations of an RFID tag according to an embodiment of the present invention.

### DETAILED DESCRIPTION OF THE INVENTION

The aforementioned present invention will be described in more detail with reference to the accompanying drawings and by showing embodiments.

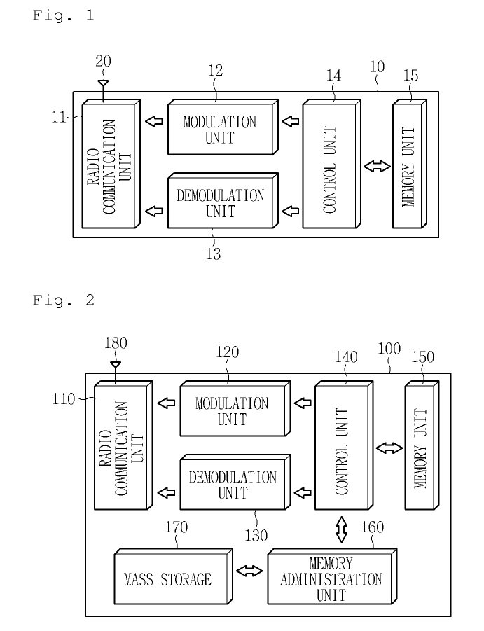

FIG. 1 is a basic block diagram illustrating a typical radio frequency identification (RFID) tag, which includes an antenna 20 for communicating with an external reader device and a tag chip 10. The tag chip 10 is typically a semiconductor chip, but may be not a chip depending on its applications. Typically, the tag chip 10 includes: a wireless communication unit 11 connected to the antenna 20 to facilitate amplification and filtering required to receive/transmit radio signals; a demodulation unit 13 for demodulating the signals received from the wireless communication unit 11 to obtain digital data; a modulation unit 12 for modulating the digital data into a signal type adequate to transmission to the wireless communication unit 11; a control unit 14 for recognizing the meaning of the data received by the demodulation unit 13, performing corresponding operations, and transmitting result data via the modulation unit 12 after reading or writing required information, if necessary, from a memory unit 15. If a passive tag is used in addition to the tag chip 10 and the antenna 20, an electric charging means for utilizing induced electric current as a power source may be added. If an active tag is used, a battery may be added.

Such a basic configuration of the RFID tag may be provided to various applications such as when identification information should be provided for entrance-or-exit control or access control, when particular environment change information is updated and stored, when security information is decrypted and relating processing is performed, and when particular information is encrypted and security processing is performed.

Such a typical RFID application has been limitedly used in several fields such as simple information exchange, authentication, or logistic management by transmitting a small size of information. However, as needs for a portable reader device and high quality information increases, the number of applications requiring transmission of large scale information is accordingly increasing.

For example, the RFID tag currently used in the access control may require an application capable of providing image or video information in addition to the identification function using simple text information, as well as an application capable of providing administration information such as product images or cautions of the items in addition to simple text information on logistics.

Particularly, the current RFID tag may require an application capable of additionally obtaining large scale information, if necessary, from the tag while maintaining the identification function using basic text information. For example, basic services such as authentication, logistics, and guidance may be processed as fast as possible based on the text information, while additional services requiring additional authentication or confirmation of specific or additional information may be processed by identifying information after requesting corresponding information to the tag and receiving large scale data.

However, since the RFID tag basically has been designed to produce a small size of inexpensive tags and utilize them with easy administration, the active tags may be highly required to be administrated because battery consumption seriously increases when a large capacity of memory is used to transmit large scale data. Further, it may be difficult to apply the passive tags to a large capacity of memory because they should be driven by electrical power induced by the reader device.

FIG. 2 illustrates a configuration of a tag capable of reducing power consumption while utilizing a large capacity of memory according to an embodiment of the present invention. In this configuration, large scale streaming data can be transmitted even using the passive tag, while a low power operation can be performed even using the active tag, so as to reduce battery consumption.

The illustrated tag chip 100 includes: a typical antenna 180, a wireless communication unit 110, a modulation unit 120, a demodulation unit 130, and a control unit 140. Further, it may include a memory unit 150, which is a nonvolatile memory capable of updating information whenever it is necessary to transmit/receive information required to be updated. In addition to such a basic configuration, the tag chip 100 may include: a mass storage 170 for sequentially storing one or more pieces of large scale streaming data; and a memory administration unit 160 for administrating operations of the mass storage 170 to obtain and provide streaming data required by the control unit 140.

Since the memory unit 150 is a rewritable nonvolatile memory, it has large power consumption, and a large capacity of memory cannot be used for it.

Meanwhile, the illustrated mass storage 170 may be a memory basically comprising fixed information for reading operations, or a rewritable memory capable of modifying corresponding information. However, at least a region for storing large scale streaming data in the corresponding mass storage 170 is preferably used as a read-only memory when the tag is normally used.

If necessary, the mass storage 170 may be used as a rewritable memory. In other words, a part of the mass storage 170 may be used as a rewritable memory, while the other part maybe used as a read-only memory that cannot be written in a normal condition. Therefore, there is no significant meaning to distinguish between a memory unit 150 and a mass storage 170 by physical manner. Herein, the logically rewritable memory unit 150 is distinguished from the mass storage 170 which stores large scale streaming data and may be used as a read-only memory.

The mass storage 170 may have fixed information already written in an initial manufacturing stage. Otherwise, the fixed information may be written depending on various interfaces and writing environments such as a sufficient external power supply state, a separate interface connection state, and a special mode conversion, before the mass storage 170 is practically applied after manufactured as a rewritable memory. In consideration of generality and disposability of the tag, the mass storage 170 may preferably be a one-time programmable memory.

Preferably, the rewritable memory unit 150 may be inactivated to save power consumption when the mass storage 170 is used.

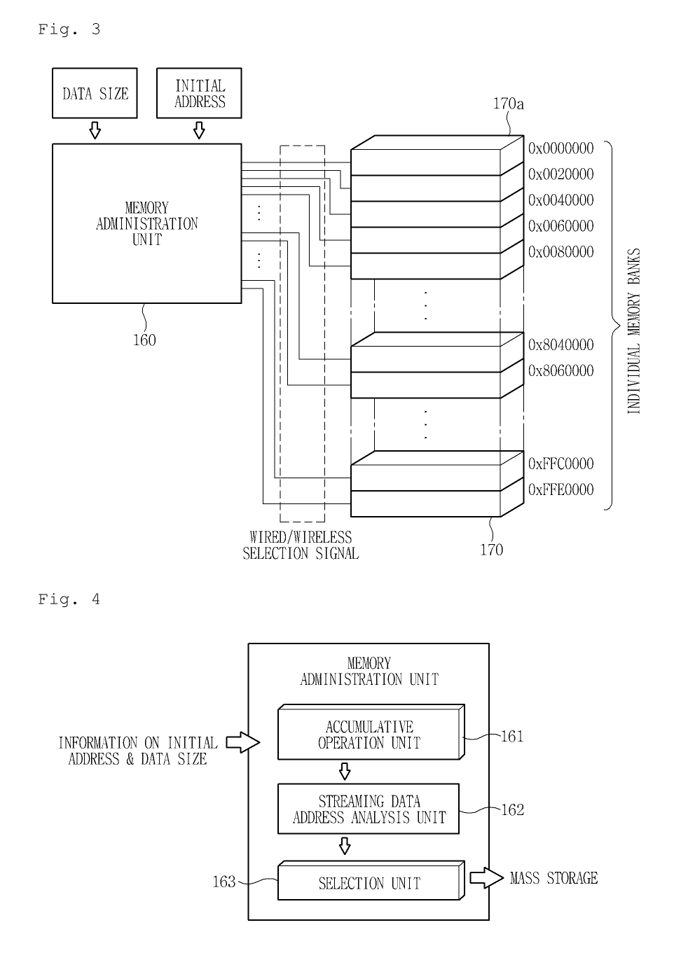

FIG. 3 illustrates the mass storage 170 and the memory administration unit 160 for describing their configurations and operations in more detail. How to obtain large scale streaming data with low power consumption will be described with reference to FIG. 3.

First, the mass storage 170 includes a plurality of unit banks having a small size. Each unit bank switches between active and inactive states depending on a signal provided from the memory administration unit 160. During the inactive state, the unit bank becomes inactivated by cutting off power supply or becomes a standby mode. The power is supplied only during the active state. In other words, the signal provided from the memory administration unit 160 may be a signal for deciding whether or not power is supplied, or a substantial power supply signal.

In the illustrated example, the mass storage may have a capacity of 256 MB, and each unit bank maybe segmented by 128 KB. As a result, the power consumption may be substantially reduced as much as the number of segmentation (in this embodiment, 1/2,000) in comparison with a conventional mass storage which is driven as a whole in a single time. In this case, the size of the memory driven in a single time is substantially limited to the size of the unit bank even in the mass storage, and thus facilitating lower power consumption.

Optionally, the memory administration unit 160 may receive from the control unit information relating to data transmission to know timing for obtaining streaming data. Although the transmission rate of the RFID communication is being improved, the data transmission rate is still slower in comparison with the time spent to obtain information from the memory. Therefore, there is no need to supply power for all time for obtaining streaming data and transmitting it even when power is sequentially supplied to the unit banks. Accordingly, it is possible to save power consumed during the data transmission using the memory administration unit 160 by obtaining the streaming data, providing it to the control unit, which allows the streaming data to be transmitted, and then, inactivating all of unit banks of the mass storage 170. After completing the transmission, the unit banks may be recovered into a previous storage state. This would be helpful to safety of the transmission data. Therefore, it is possible to ensure safe communication with low power consumption. When the transmission rate is consistent, switching between the activation and inactivation states can be made based on timing without receiving the signal from the control unit. However, it is preferable to obtain substantial transmission timing information. If a Sleep & Wakeup mode is employed, the memory administration unit 160 may become a low power consumption state depending on the transmission timing. Therefore, it is possible to further reduce power consumption.

On the other hand, the large capacity streaming data should be sequentially stored in the mass storage, and the operation of the memory administration unit 160 can be simplified by sequentially reading the streaming data. Therefore, it is possible to reduce manufacturing cost and power consumption.

In this case, the unit bank 170a of the memory unit 170 may have an address line bus (not shown) having the number of lines corresponding to the address size of the unit bank; a single activation signal line (i.e., for an activation/inactivation selection signal or an on/off power signal) controlled by the memory administration unit; and a common data line as an input/output terminal, and may require no large register for the addressing. For example, assuming that there are 256 addresses in a single bank, the unit bank of the memory unit may be constructed by providing a means for incrementing the address from 0 to 255, and a means for modifying a signal for selecting a unit bank into a signal for selecting the next bank when an overflow occurs. Therefore, there is no need to provide complicated operations or a lot of registers for the addressing even when a significant number of addresses are used. This is also helpful to reduce power consumption by lowering the number of operations or operational clocks.

Meanwhile, when the memory administration unit 160 obtains streaming data from the memory unit 170, its request information is also used. Basically, information on the initial address and the data size may be used. In other words, if information on the initial address and the data size of the memory unit 170 is provided, it is possible to know where and how much information should be sequentially transmitted from. Also, it is possible to provide a plurality of pieces of sequentially stored streaming data as desired.

Preferably, the initial address and the data size for each of the streaming data may be stored in a part of memory unit 170 (e.g., a start or end region) together with the streaming data, and then, transmitted on a top priority when the tag starts to communicate with an external reader device. Therefore, the external reader device may request the necessary streaming data using information on the initial address and the data size when the large capacity streaming information is necessary.

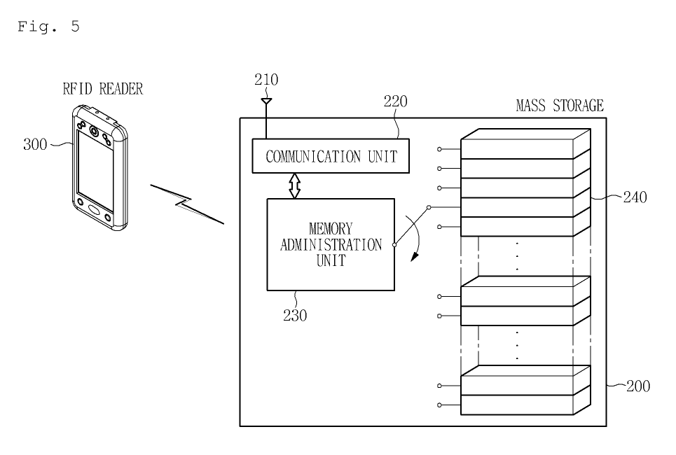

FIG. 4 is illustrates a configuration example of the memory administration unit 160. As shown in FIG. 4, the memory administration unit 160 includes: an accumulated operation unit 161 which obtains information on the initial address and the data size, and increments the current address until the amount of data obtained by incrementing the address starting from the initial address reaches the data size; an streaming data address analysis unit 162 which selects a unit bank to be activated from the mass storage based on the incremented address information and determines an address in the unit bank; and a selection unit 163 which provides the unit bank selected by the streaming data address analysis unit 162 with a power or activation signal and provides a signal for selecting an address in the unit bank. Needless to say, the detailed structure for such operation may be implemented in a variety of manner, and is not limited to the aforementioned ones.

There have been many methods of operating only a portion of the memory unit in order to reduce power consumption of a high-speed volatile memory such as a Cache memory. Unfortunately, in such conventional methods, only a portion of the memory unit required for write/read operations is activated in order to reduce power consumption caused by continuous high-speed operation due to properties of a Cache memory. Also, the data frequently changes depending on the write/read operations. Because the data is independently distributed even when the streaming data is continuous, an additional means such as a file allocation table or a scheduler becomes indispensable. These operations are basically made under administration of an operating system. Therefore, the conventional methods are not applicable to the memory administration of the RFID tag which requires a simpler structure, a reduced number of operations, and lowered operational loads. On the other hand, according to the present embodiment, the streaming data that has been continuously written is read in a simple manner while minimizing power consumption. Therefore, the proposed structure and operation method are proper for the RFID tag which requires low power consumption, a relatively low operation speed, a reduced cost for a control part.

FIG. 5 illustrates a method of operating an RFID reader device 300 and a tag 200 in which the mass storage according to the above embodiment is employed. In FIG. 5, a control unit in the tag 200 is substituted with the memory administration unit 230, and a separate rewritable memory is not provided.

It is assumed that the tag 200 comprises: an antenna 210; a communication unit 220; a memory administration unit 230; and a mass storage 240 having a plurality of unit banks controlled by the memory administration unit 230, and the tag 200 is a passive tag.

First, if the RFID reader device 300 stays adjacent to the tag 200, and provides induction current to the tag 200, the tag 200 starts to communicate with the RFID reader device 300. At the same time, information on the initial address and the data size of the streaming data stored in the mass storage 240 is provided to the RFID reader device 300. Additional information such as a data format or a file name can be optionally provided. They may be provided in plural.

If the RFID reader device 300 provides the tag 200 with information on the initial address and the data size of desired streaming data, the memory administration unit 230 obtains the information via the communication unit 220, and repeats streaming transmission by incrementing the address starting from the initial address until the amount of data obtained by incrementing the address reaches the data size. In this repetition, the memory administration unit 230 sequentially provides the RFID reader device 300 with the streaming data while sequentially selects the unit banks of the mass storage 240. It should be noted that the memory administration unit 230 operates only the selected unit bank, and keeps the others in an invalid state (also represented as an inactivated state, a low power state, a sleep state, or a no-power state), while inactivates the unit banks selected in the transmission process, in order to minimize power consumption. On the other hand, if the RFID reader device 300 shares the information relating to the streaming data stored in the tag in the initial communication, the streaming data corresponding to the desired information on the initial address and the data size may be requested not by providing information on the initial address and the data size, but by providing simple identification information indicating corresponding information.

Through the above process, the RFID reader device 300 is allowed to obtain large scale information from the passive tag 200 and utilize it. For example, if the passive tag 200 as described above is applied to exhibits in a museum or the like, information such as pictures or videos can be provided by the RFID reader device 300. If the RFID reader device 300 has generality, any program, application, web page, or Flash file that can be executed on the RFID reader device 300 may be delivered using the RFID tag, so that the dynamic high-quality information can be readily obtained using the RFID tag. On the other hand, if the RFID tag is a passive tag, a separate maintenance is not necessary, and it can be used semi-permanently.

According to an embodiment of the present invention, a mass storage is segmented into unit banks, and only the unit banks are selectively operated in a sequential manner. As a result, it is possible to manufacture a tag capable of streaming transmission of large scale data with low power consumption.

According to an embodiment of the present invention, a method of administrating a mass storage can be applied to a passive tag as well as a active tag using a sequential transmission characteristic of fixed large scale streaming data. As a result, it is possible to significantly improve applicability of the passive tag, which had difficulty due to power limitation, as well as battery lifetime of the active tag.

According to an embodiment of the present invention, a mass storage is segmented into small unit banks, and the unit banks are selectively activated in a sequential manner using a sequential transmission characteristic of the fixed large scale streaming data. As a result, it is possible to obtain large scale data as desired only with minimum power consumption by using information on an initial address and a data size.

According to an embodiment of the present invention, a control unit is substituted with a memory administration unit which partially operates a mass storage based on an initial address and a data size. As a result, it is possible to reduce cost for a tag which provides large scale information.

According to an embodiment of the present invention, a data streaming apparatus for an RFID tag has a mass storage dedicated to fixed data as well as a small scale memory for rewritable data. Furthermore, the mass storage is partially driven depending on necessity in order to minimize power consumption and cover various applications. As a result, it is possible to maximize applicability of the RFID tag.

What is claimed is:

1. A data streaming apparatus applied to a memory administration means of a tag for radio frequency identification communication, the apparatus comprising:
a memory unit including a plurality of unit banks capable of switching between active and inactive states, one or more unit banks sequentially storing one or more pieces of streaming data; and
a memory administration unit receiving information on an initial address or a data size or identification information corresponding to the initial address or the data size and obtaining and providing data by selectively activating only the unit bank corresponding to a current address while incrementing the current address until the amount of data obtained by incrementing the address starting from the initial address reaches the data size.

2. The data streaming apparatus according to claim 1, wherein the memory unit is activated or inactivated depending on a selection signal of the memory administration unit, and the address sequentially designates each of the unit banks based on the size of the entire memory unit.

3. The data streaming apparatus according to claim 1, wherein the unit bank of the memory unit includes: an address line bus having a number of lines corresponding to an address size of the unit bank; a single activation signal line controlled by the memory administration unit; and a common data line as an input/output terminal.

4. The data streaming apparatus according to claim 1, wherein the memory administration unit includes:
a receive unit receiving the information on the initial address and the data size;
a accumulative operation unit generating the current address by incrementing from the initial address until an accumulative data amount reaches the data size; and
a selection unit calculating unit bank information of the memory unit to be currently operated from the address value of the accumulative operation unit and the address of the corresponding unit bank, activating only the corresponding unit bank, and designating the address in the corresponding unit bank.

5. The data streaming apparatus according to claim 1, wherein the memory unit includes information on the initial address and the data size of stored streaming data, and the tag provides corresponding information or an identifier indicating the information when the tag is connected to a reader device.

6. The data streaming apparatus according to claim 1, wherein the memory administration unit increments the address after receiving from external control information a fact that the obtained data is not provided any more.

7. The data streaming apparatus according to claim 1, wherein the memory administration unit inactivates all unit banks in the memory unit until an external signal notifying that radio transmission of the corresponding data is completed is provided after the obtained data is provided.

8. The data streaming apparatus according to claim 1, wherein the memory administration unit inactivates all unit banks in the memory unit if the information on the initial address and the data size is not received or after all information has been provided.

9. The data streaming apparatus according to claims 1, wherein the (RFID) tag is a active tag or a passive tag.

10. A data streaming apparatus for a radio frequency identification (RFID) tag, the apparatus comprising:
a wireless communication unit exchanging data with an external reader device;
a modulation/demodulation unit transmitting/receiving data to/from via wireless communication unit;
a memory unit having a plurality of unit banks capable of switching between active and inactive states, one or more pieces of the streaming data being sequentially stored in one or more unit banks;
a control unit outputting information for requesting the streaming data stored in the memory unit in response to a streaming data request received via the modulation/demodulation unit and receiving the streaming data accordingly to provide it to the modulation/demodulation unit; and
a memory administration unit obtaining data and provide it to the control unit while sequentially activating necessary unit banks in the memory unit based on the information for requesting the streaming data from the control unit.

11. The data streaming apparatus according to claim 10, wherein the control unit further comprises a state notification means for providing the memory administration unit with information for requesting subsequent data after receiving the streaming data from the memory administration unit and transmitting it to the modulation/demodulation unit, and
wherein the memory administration unit further comprises a synchronization means for sequentially providing the streaming data depending on a transmission state provided by the state notification means of the control unit.

12. The data streaming apparatus according to claim 11, wherein the memory administration unit inactivates the entire memory unit until receiving the information for requesting subsequent data after providing the control unit with the streaming data.

13. The data streaming apparatus according to claim 10, wherein the memory unit has information on an initial address and a data size of the stored streaming data,
and the control unit provides corresponding information and an identifier indicating the information when it is connected to a reader device.

14. The data streaming apparatus according to claim 10, wherein the memory administration unit is integrated into the control unit as a partial constituent.

15. The data streaming apparatus according to claim 10, further comprising a update memory controlled by the control unit to store update information, wherein the update memory is inactivated when the streaming data of the memory unit is transmitted.

16. The data streaming apparatus according to claim 10, wherein the information for requesting the streaming data output from the control unit includes the initial address and the data size,
and the memory administration unit includes a means for activating only a unit bank corresponding to a current address while incrementing the initial address until the amount of transmitted data reaches the data size and designating an address of the corresponding unit bank.

17. The data streaming apparatus according to claim 16, wherein the memory unit has information on an initial address of a data size of the stored streaming data, and the control unit provides the corresponding information when it is connected with a reader device.

18. The data streaming apparatus according to claims 10, wherein the (RFID) tag is a active tag or a passive tag.

19. A data streaming apparatus for a radio frequency identification (RFID) tag, the apparatus comprising:
a wireless communication unit exchanging data with an external reader device;
a modulation/demodulation unit transmitting/receiving data via the wireless communication unit;
a memory unit including a plurality of unit banks capable of switching between active and inactive states and sequentially storing one or more pieces of streaming data in one or more unit banks; and
a memory administration unit obtaining the streaming data and providing it to the modulation/demodulation unit while sequentially activating necessary unit banks in the memory unit in response to a streaming data request received by the modulation/demodulation unit.

20. The data streaming apparatus according to claim 19, wherein the memory administration unit inactivates the entire memory unit while transmits the streaming data to the modulation/demodulation unit
